(19) United States
(12) Patent Application Publication
(10) Pub. No.: US 2011/0173621 A1
(43) Pub. Date: Jul. 14, 2011

(54) PUSH-BASED OPERATORS FOR PROCESSING OF PUSH-BASED NOTIFICATIONS

(75) Inventors: Henricus Johannes Maria Meijer, Mercer Island, WA (US); John Wesley Dyer, Monroe, WA (US); Jeffrey van Gogh, Redmond, WA (US); Danny van Velzen, Redmond, WA (US); Brian Beckman, Newcastle, WA (US); Mark Shields, Seattle, WA (US)

(73) Assignee: MICROSOFT CORPORATION, Redmond, WA (US)

(21) Appl. No.: 12/686,950

(22) Filed: Jan. 13, 2010

(51) Int. Cl. G06F 9/46; G06F 9/54

(52) U.S. Cl. 718/102; 719/318

(57) ABSTRACT

A library of operators is provided for performing operations on push-based streams. The library may be implemented in a computing device. The library may be stored on a tangible machine-readable medium and may include instructions to be executed by one or more processors of a computing device. The library of operators may include groups of operators for performing various types of operations regarding push-based streams. The groups of operators may include, but not be limited to, standard sequence operators, other sequence operators, time operators, push-based operators, asynchronous operators, exception operators, functional operators, context operators, and event-specific operators.

### BACKGROUND

Synchronous programming is straightforward. When a call to a function is made, a calling thread is blocked and waits until the function is completed before being unblocked. However, asynchronous programming is much more difficult for software developers than synchronous programming. In asynchronous programming, a thread that initiates an asynchronous call to a function is not blocked and can perform other processing before the function has completed. Thus, asynchronous programming allows parallel processing, but can introduce several complications.

As an example of some of the complications that can occur in asynchronous message passing, a method call initiated by a caller process may not be delivered to a callee object. Because the caller process does not wait for the message to be delivered to the callee object, the caller process will not be notified of an error concerning delivery of the message. Either operating systems provide an infrastructure for reporting such errors, or software developers write code to anticipate and handle such errors.

As another example of some of the complications that can occur in asynchronous programming, if a caller process does not wait for completion of a called function, how will the caller process learn of the completion of the call function? One solution is for a caller application to create a callback method, a polling mechanism, or an event trigger through which the caller application can be notified of the completion of the call function. However, this further complicates coding when compared with straightforward synchronous programming.

Currently, programming languages and libraries provide support for synchronous and pull-based programming, but provide very little support for asynchronous and event-based programming. Due to this and difficulties software developers have with asynchronous and event-based programming, software developers often break their computer code into a number of disjoint event-handlers and use an explicit continuation passing style. The lack of a simple programming model for asynchronous and event-based programming has become problematic for software developers due to the introduction of many-core computers, distributed computing and cloud computing.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a library of operators to be implemented in a computing devices is disclosed. The operators may perform operations on one or more push-based streams. The operators may be included in a number of different groups of operators including standard sequence operators, other sequence operators, time operators, asynchronous operators, exception operators, push-based operators, context operators, event-specific operators and functional operators.

Standards sequence operators may perform basic operations on one or more push-based streams including, but not limited to, a grouping operation to group notifications from a push-based stream, a skipping operation to skip notifications of a push-based stream, a union of notifications from push-based streams, an intersection of notifications from push-based streams, as well as other operations.

Other sequence operators may perform more complex operations than standard sequence operators, including, but not limited to, operations involving contiguous notifications, grouping of notifications until a given predicate is false, partitioning of notifications, as well as other operations.

Time operators may perform operations such as, delaying firing of a notification, generating a notification with a boolean value based upon a timing of an arrival of a notification, generating a push-based stream based on sampling notifications of a provided push-based stream, as well as other operations.

Push based operators may perform operations such as, caching a notification, such that the notification may be fired when a handler is added to process notifications of an associated push-based stream, generating a stream which is identical to one of multiple push-based streams that first fires a notification, returning a stream or throwing a timeout exception based on a notification occurring in a push-based stream within a given time period, as well as other operations.

Asynchronous operators may perform operations including, but not limited to, creating a stream which fires a first notification once multiple push-based streams have fired notifications, immediately starting a given function that fires a notification upon completion, starting a notification computation and waiting for a first given number of notifications before returning an array with values from the first given number of notifications, as well as other operations.

Exception operators may perform operations including, but not limited to, refiring a notification for each successful notification on a push-based stream, creating a stream with a notification including an exception, specifying a function to execute when an exception occurs in a push-based stream, as well as other operations.

Functional operators may perform operations including, but not limited to, deferring execution of a function until a handler is added to a push-based stream to process notifications and giving a name to a notification.

Context operators may perform operations including, but not limited to changing a notification processing context to one of a number of contexts.

Event-specific operators may perform operations including, but not limited to, adding a handler to process notifications on a push-based stream, adding code to be executed when removing a handler from a push-based stream, converting a push-based stream to a pull-based stream, as well as other operations.

### DRAWINGS

In order to describe the manner in which the above-recited and other advantages and features can be obtained, a more particular description is described below and will be rendered by reference to specific embodiments thereof which are illustrated in the appended drawings. Understand that these drawings depict only typical embodiments and are not therefore to be considered to be limiting of its scope. Implementations will be described and explained with additional specificity and detail through the use of the accompanying drawings.

FIG. 1 is a block diagram of an exemplary computing device, which may be used to implement embodiments consistent with subject matter of this disclosure.

FIG. 2 illustrates exemplary groups of operators included in a library of operators for performing operations on notifications in push-based streams.

FIGS. 3-23 illustrate exemplary operations of a number of operators which may be included in the library of operators.

### OVERVIEW

In embodiments consistent with the subject matter of this disclosure, a library is disclosed having a number of operators for performing operations on asynchronous or push-based notifications in push-based streams. The library may be implemented in a computing device and may include a number of different types of operators, such as, for example, standard sequence operators, other sequence operators, time operators, asynchronous operators, exception operators, push-based operators, context operators, event-specific operators and functional operators.

### Exemplary Processing Devices

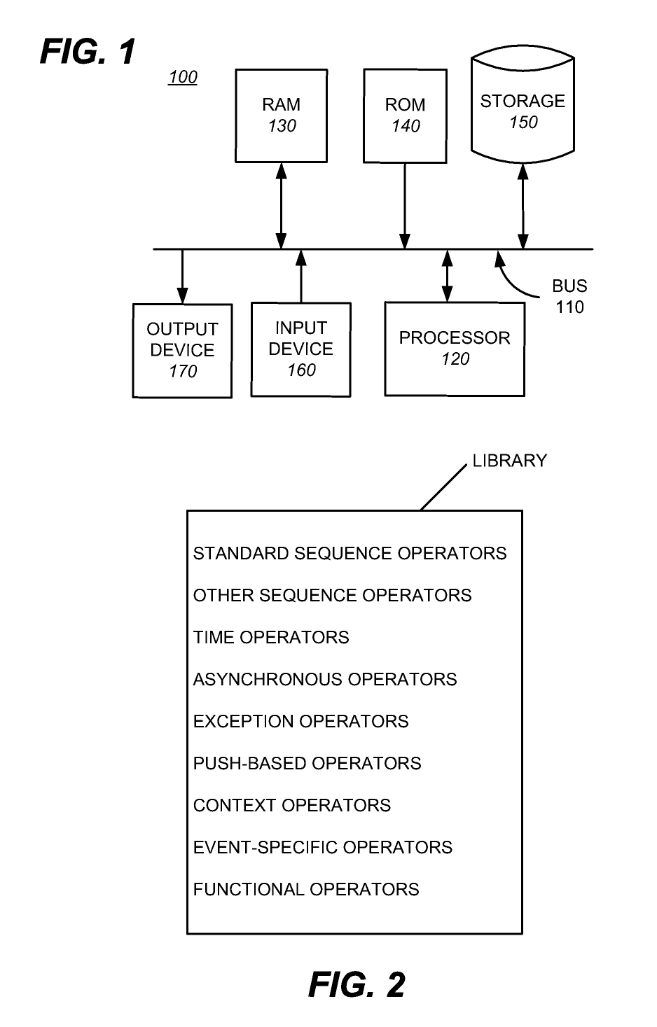

FIG. 1 is a block diagram of an exemplary computing device 100, which may be used to implement embodiments consistent with the subject matter of this disclosure. The computing device 100 may be a personal computer (PC), a handheld computing device, or another type of computing device. Computing device 100 may include hardware, such as at least one processor 120, a system bus 110, a memory, which may include a combination of random access memory (RAM) 130 and read only memory (ROM) 140, a storage device 150, an input device 160 and an output device 170.

Processor 120 may include one or more conventional processors that interpret and execute instructions. RAM 130, ROM 140, and/or another type of dynamic or static storage device may store information and instructions for execution by processor 120. RAM 130, or another type of dynamic storage device, may store instructions as well as temporary variables or other intermediate information used during execution of instructions by processor 120. ROM 140, or another type of static storage device, may store static information and instructions for processor 120.

Input device 150 may include a keyboard, a pointing device, or other device for providing input. Output device 160 may include a display, a printer, or other device for outputting information.

Storage device 150 may include a magnetic disk, a writable optical disc, a flash RAM device, or other type of storage device for storing data, instructions, or other information. Non-limiting examples of storage device 150 may include Digital Video Disk (DVD), Compact Disk (CD), or other types of storage devices.

Computing device 100 may communicate with other devices via a network and may perform functions in response to processor 120 executing sequences of instructions contained in a tangible machine-readable medium, such as, for example, RAM 130, ROM 140, optical disk, flash RAM, or other medium. Such instructions may be read into RAM 130 from another tangible machine-readable medium or from a separate device via a communication interface (not shown).

### Embodiments

One embodiment consistent with the subject matter of this disclosure uses Language Integrated Query (LINQ), which is a component of Microsoft Corporation's .NET framework. LINQ defines query operators for querying, projecting, and filtering data in enumerable (pull-based) classes, arrays, relational databases, eXtensible Markup Language (XML), and other data sources. However, LINQ may be used in conjunction with a library of push-based operators for processing push-based notifications in order to query, project, and filter data in observable (push based) classes, arrays and various data sources. In some embodiments, the library may include standard sequence operators, other sequence operators, time operators, push-based operators, asynchronous operators, exception operators, functional operators, context operators and event-specific operators as shown in FIG. 2, which illustrates an exemplary library consistent with the subject matter of this disclosure. In other embodiments, a language other than LINQ may be used in conjunction with the library and the library may include additional operators or a different mix of operators than as shown in the exemplary library of FIG. 2.

### Standard Sequence Operators

In one embodiment consistent with the subject matter of this disclosure, the standard sequence operators may include a Distinct operator, a GroupBy operator, a GroupJoin operator, an Intersect operator, a Join operator, a Skip operator, a SkipWhile operator, a TakeUntil operator, a TakeWhile operator, a Union operator and a Where operator.

The Distinct operator ensures that for each distinct key value of an notification, as determined by a key selector, at most one notification with a value may be fired in a resulting push-based notification stream.

The following is an example of how the Distinct operator may be used.

var result=e.Distinct (IsOdd)

where result may be a resulting push-based stream generated after applying the Distinct operator to e, which may be a provided push-based stream. The Distinct operator may cause a key selector to be applied to respective values of notifications of the provided push-based stream and may generate the resulting push-based stream based on distinct values of respective key selectors.

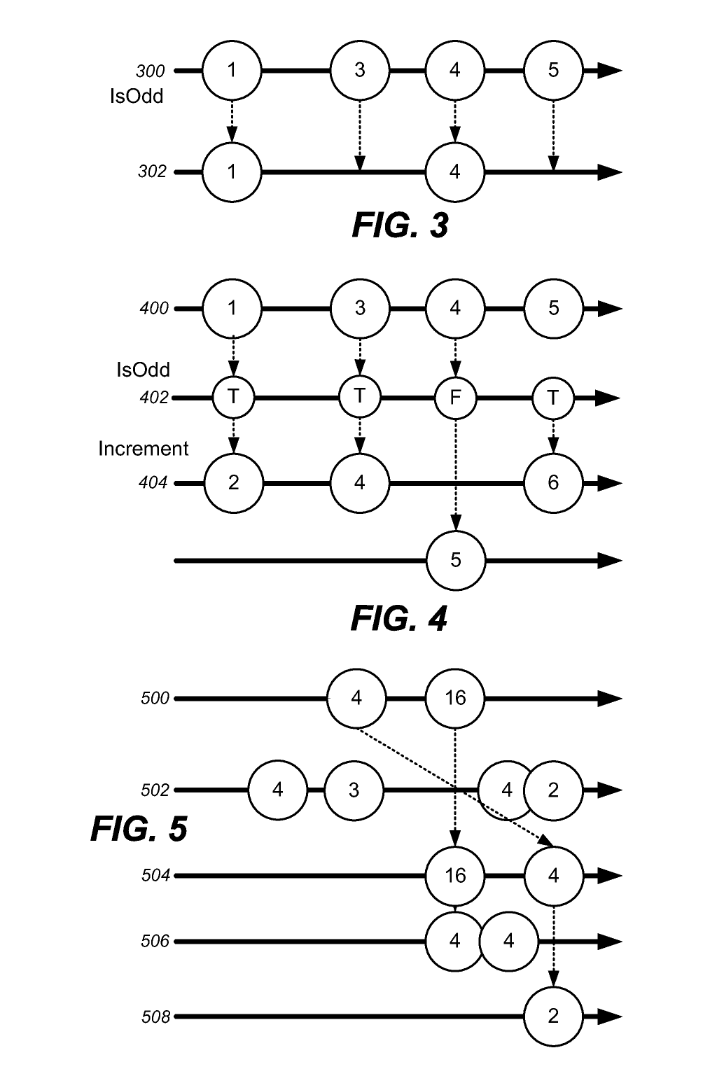

FIG. 3 illustrates an exemplary push-based stream 300 having notifications with values of 1, 3, 4 and 5. Applying Distinct to push-based stream 300 results in push-based stream 302. For example, applying key selector “IsOdd” to 1 generates a boolean value of true, which causes a notification with a value of 1 to be fired onto push-based stream 302. Applying the key selector to a notification with a value of 3 generates a boolean value of true, which now is not distinct and causes no notification to be generated to a push-based stream 302. Applying the key selector to a notification with a value of 4 causes a boolean value of false to be generated, and because no other value of false has yet been generated, a notification with a value of 4 is fired onto push-based stream 302. Applying the key selector to a notification with a value of 5 causes a boolean value of true to be generated, which is not distinct. Therefore, no corresponding notification will be fired onto push-based stream 302.

The GroupBy operator may group values of notifications in a given push-based stream into equivalence classes as determined by a key selector, where each group may contain a notification stream of values as determined by an element selector.

The following is an example of how the GroupBy operator may be used.

var result=e.GroupBy (IsOdd, Increment)

where result is a push-based stream generated by applying the GroupBy operator to e, which is a provided push-based stream. As previously, “IsOdd” is a key selector and “Increment” is an element selector.

With reference to FIG. 4, applying the key selector, IsOdd, of the GroupBy operator to a first notification, with a value of 1, in a provided push-based stream 400, generates a boolean value of true. Applying the element selector, Increment, to the value of 1 generates a notification with a value of 2. When applying the key selector to a value of a notification generates a boolean value of true, a resulting notification may be fired onto a push-based stream 402. When applying the key selector to a value of the notification generates a boolean value of false, the resulting notification may be fired onto a push-based stream 404. Thus, as shown in FIG. 4, the GroupBy operator may fire notifications with incremented values onto push-based stream 402 for each notification with an odd value in push-based stream 400. The GroupBy operator may fire notifications with incremented values onto push-based stream 404 for each notification with an even value in push-based stream 400.

The GroupJoin operator operates on two streams. The GroupJoin operator takes each respective notification in a first push-based stream and pairs each of the respective notifications with a stream of notifications from a second push-based stream that are equal to the respective notifications in the first push-based stream as determined by a selector function.

The following is an example of how the GroupJoin operator may be used.

var result=e1.GroupJoin (e2, Identity, Square, (x, g)=>new {x, g});

where e1 represents a first provided push-based stream and e2 represents a second provided push-based stream. Identity and Square are a first and a second key selector, respectively. With reference to FIG. 5, a push-based stream 500 corresponds to e1 and a push-based stream 502 correspond to e2. “new {x, g}” correspond to a function to be applied to x and matching notifications from push-based stream 502. In this example, new {x, g} generates a notification having a value of x onto push-based stream 504 and g represents a matching stream of grouped notifications from push-based stream 502.

Using the two selector functions, the GroupJoin operator will attempt to match Identity (x) with Square (g), where x is a value of a notification from push-based stream 500 and g is a value of a notification from push-based stream 502. Because Identity (16)=Square (4) and Identity (4)=Square (2), a generated result includes a notification with a value of 16, in a resulting push-based stream 504, paired with a stream of notifications from push-based stream 502 that match 16, according to the key selectors, and a notification with a value of 4, in resulting push-based stream 504, paired with a stream of notifications from push-based stream 502 that match 4, according to the key selectors. A notification with a value of 16, selected from push-based stream 500, may be generated onto push-based stream 504 and a matching notification stream with values of 4, selected from push-based stream 502, may be generated onto push-based stream 506. A notification with a value of 4, selected from push-based stream 500, may be generated onto push-based stream 504 and a matching notification with a value of 2, selected from push-based stream 502, may be generated onto push-based stream 508.

The Intersect operator operates on notifications from two push-based streams and fires, onto a resulting push-based stream, only those notifications whose values occur in both of the push-based streams.

The following is an example of how the Intersect operator may be used.

var result=e1.Intersect(e2);

where e1 and e2 are provided push-based streams and result is a generated push-based stream. With reference to FIG. 6, a notification with a value of 4 is an only notification with that value that appears in both push-based stream 600 and push-based stream 602. Therefore, in this example, the Intersect operator would generate push-based stream 604 having only one notification, which has a value of 4.

The Join operator is similar to the GroupJoin operator. Given two push-based streams, the Join operator takes each pairwise equal pair of notifications, as determined by two key selectors, and projects out the pair of notifications onto a resulting push-based stream using a selector function. For example,

var result=e1.Join (e2, Identity, Square, Add);

where e1 and e2 are provided push-based streams, Identity and Square are key selectors and Add is a selector function.

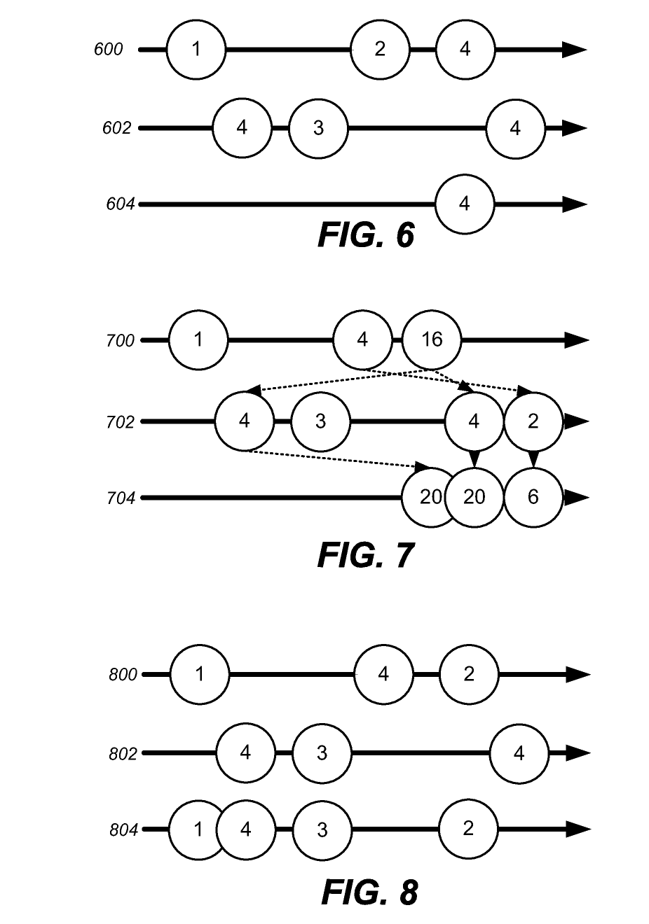

With reference to FIG. 7, push-based streams 700 and 702 correspond to e1 and e2, respectively, and result corresponds to push-based stream 704. Identity and Square are two key selectors and Add is a selector function. One can see that Identity (16), where 16 is a value of a notification from push-based stream 700, and Square (4), where 4 is a value of a notification from push-based stream 702, are equal according to the key selectors. Similarly, one can see that Identity (4), where 4 is a value of a notification from push-based stream 700, and Square (2), where 2 has a value of a notification from push-based stream 702, are equal according to the key selectors. Therefore, 16 from push-based stream 700 and 4 from push-based stream 702 form one pair while 4 from push-based stream 700 and 2 from push-based stream 702 form a second pair. Applying the selector function, in this example, Add, 16 and 4 cause a notification with a value of 20 to be generated onto push-based stream 704 and 4 and 2 cause a notification with a value of 6 to be generated onto push-based stream 704. Of course, the Join operator may be used with other key selectors and selector functions other than Identity, Square and Add.

The Skip operator will cause the first n notifications in a provided push-based stream to be skipped before notifications from the provided push-based stream are fired onto a resulting push-based stream, where n is a positive integer. For example, if n is 2, then

var result=e.Skip(2)

would cause a first two notifications of a provided push-based stream, e, to be skipped before notifications from the provided push-based stream, e, are fired onto a resulting push-based stream, result. Of course, as mentioned above, other positive integer values may be used instead of 2.

The SkipWhile operator is similar to the Skip operator. The SkipWhile operator skips notifications from a provided push-based stream while a given predicate is true. When the predicate is false for one notification of the provided push-based stream, the one notification and any remaining notifications may be fired onto a resulting push-based stream. For example,

var result=e.SkipWhile (IsOdd);

where result is a resulting push-based stream, e is a provided push-based stream and IsOdd is a predicate, causes notifications of the provided push-based stream to be skipped while the notifications have an odd value. Once a notification with an even value is found in the provided push-based stream, the notification with the even value and all remaining notifications from the provided push-based stream are fired onto the resulting push-based stream.

The TakeUntil operator causes only a first n notifications of a provided push-based stream to be fired onto a resulting push-based stream, where n is a positive integer. For example,

var result=e.TakeUntil(2);

where result is a resulting push-based stream, e is a provided push-based stream and n is 2, causes only a first two notifications of the provided push-based stream, e, to be fired onto the resulting push-based stream, result. Of course, any positive integer may be used instead of the integer 2.

The TakeWhile operator is similar to the Take operator. The TakeWhile operator fires notifications from a provided push-based stream onto a resulting push-based stream until a given predicate is false. When the predicate is false for one notification of the provided push-based stream, the one notification and any remaining notifications of the provided push-based stream are ignored. For example,

var result=e.TakeWhile (IsOdd);

where result is a resulting push-based stream, e is a provided push-based stream and IsOdd is a predicate, causes notifications of the provided push-based stream, e, to be fired onto the resulting push-based stream, result, while the notifications have an Odd value. Once a notification with an even value is found in the provided push-based stream, e, the notification with the even value and all remaining notifications from the provided push-based stream are ignored.

The Union operator fires notifications from two provided push-based streams onto a resulting push-based stream, but only fires notifications with any particular value at most once. For example, with reference to FIG. 8,

var result=e1.Union (e2);

where result is a resulting push-based stream corresponding to push-based stream 804, and e1 and e2 are provided push-based streams corresponding to push-based streams 800 and 802, respectively, causes notifications from push-based stream 800 and push-based stream 802 to be fired onto push-based stream 804 without duplicating a value from a notification from push-based streams 800 and 802. Thus, preceding from left to right, a notification with a value of 1 from push-based stream 800 may fire onto push-based stream 804, an notification with a value of 4 from push-based stream 802 may fire onto push-based stream 804, a notification with a value of 3 from push-based stream 802 may fire onto push-based stream 804, a notification with a value of 4 from push-based stream 800 may not fire onto push-based stream 804 because a notification with a duplicate value would be generated, a notification with a value of 2 from push-based stream 800 may fire onto push-based stream 804, and a notification with a value of 4 from push-based stream 802 may not fire onto push-based stream 804 because a notification with a duplicate value would be generated.

The Where operator filters notifications when a predicate is not true. For example,

var result=e.where (IsOdd);

where result is a resulting push-based stream, e is a provided push-based stream and IsOdd is a predicate, causes notifications having an odd value from e to be fired onto the resulting push-based stream, result, while filtering notifications not having an odd value from being fired onto result.

### Other Sequence Operators

In an embodiment consistent with the subject matter of this disclosure, other sequence operators may include a Delta operator, a Do operator, a HoldUntilChanged operator, an Iterate operator, a Partition operator, a Prepend operator, a Recurse operator, a Repeat operator, a Span operator, an Unzip operator and a Zip operator.

The Delta operator creates a stream of notifications resulting from projecting an immediately preceding notification with a current notification of a provided push-based stream (or a seed, if the current notification is a first notification).

For example,

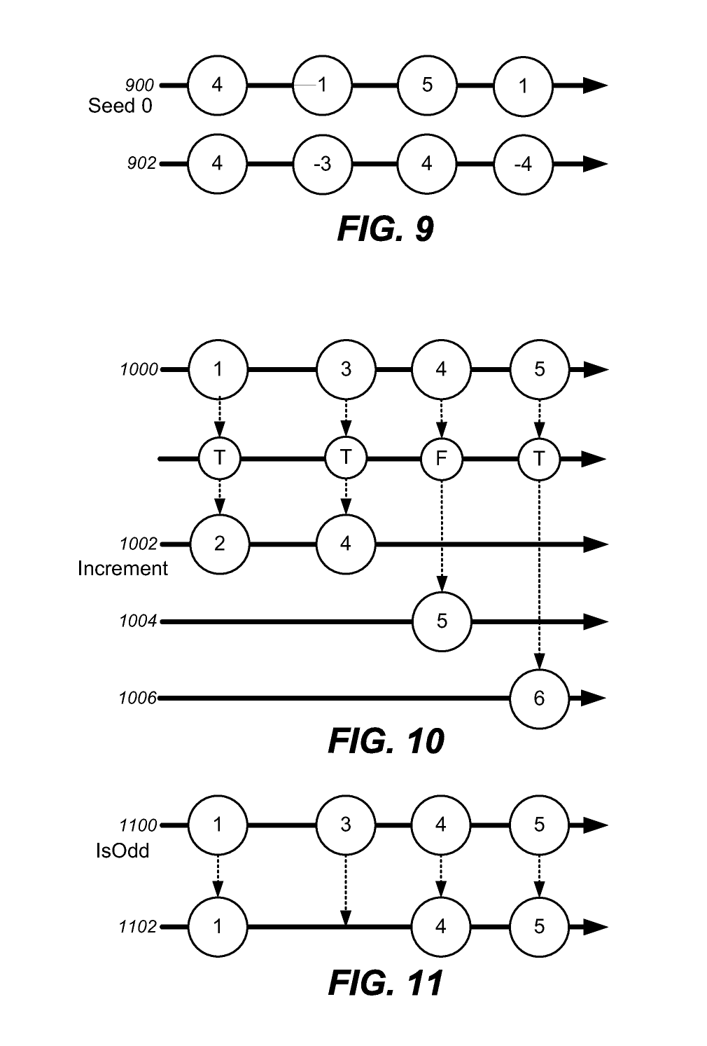

var result=e.Delta (0,Subtract);

where result is a resulting push-based stream, e is a provided push-based stream, 0 is a seed, and subtract is a function to apply to the current notification and the immediately preceding notification (or seed, if the current notification is the first notification). With reference to FIG. 9, working from left to right, 902 corresponds to the resulting push-based stream, result, and the provided push-based stream, e, corresponds to push-based stream 900. The Delta operator, in this example, will take a value of a first notification of push-based stream, 900, which in this example is 4, and subtract the seed, 0, from 4 to generate a value, 4, for a first notification of the resulting push-based stream 902. Next, the Delta operator, in this example, will take a value, 1, of a second notification of push-based stream 900 and subtract the value of the immediately preceding notification, 4, to generate a value, −3, for a second notification of the resulting push-based stream 902. The value, 5, of a third notification of push-based stream 900 has the value, 1, of the immediately preceding notification subtracted therefrom to generate a value, 4, for a third notification of push-based stream 902. The value, 1, of a fourth notification of push-based stream 900 has the value, 5, of the immediately preceding notification subtracted therefrom to generate a value, −4, for a fourth notification of push-based stream 902.

The Do operator executes a side-effecting function for each notification of a provided stream using a respective values of notifications as parameters. For example,

var result=e.Do (Console.WriteLine);

may cause values of notifications to be written to a console or monitor.

The GroupUntil operator groups values of notifications in a provided push-based stream into equivalence classes, as determined by a key selector. Each group includes a stream of values as determined by an element selector until a new group is generated or fired. As an example, consider FIG. 10 with

var result=e.GroupUntil (IsOdd, Increment);

where e corresponds to a push-based stream 1000, result corresponds to push-based streams 1002, 1004 and 1006, IsOdd is an element selector, and Increment is a function performed on values of notifications from push-based stream 1000.

Working from left to right, applying the element selector, IsOdd, to a notification with a value of 1 from push-based stream 1000, generates a boolean value of true (because 1 is an odd value), thereby causing a notification with a value of 2 (as a result of applying Increment to the value 1) to be generated to push-based stream 1002. Applying the element selector, IsOdd, to a value of 3 of a second notification of push-based stream 1000 generates a boolean value of true, thereby causing a notification with a value of 4 to be generated to push-based stream 1002. Note that the generated notifications are grouped in push-based stream 1002 because values of corresponding notifications in push-based stream 900 are odd, as determined by element selector IsOdd.

Applying the element selector, IsOdd, to a value of 4 of a third notification of push-based stream 1000 generates a boolean value of false. Because the value of 4 is not equivalent to the previous value, as determined by IsOdd, 4 is incremented and a notification with a value of 5 is generated onto a push-based stream 1004, thereby starting a new group. Applying the element selector, IsOdd, to a value of 5 of a fourth notification of push-based stream 1000 generates a boolean value of true, which is different from the previously generated boolean value indicating a group change. The value of 5 is incremented and a notification with a value of 6 is generated onto another push-based stream 1006.

The HoldUntilChanged operator generates notifications to a resulting push-based stream from a provided push-based stream while removing all non-distinct contiguous notifications as determined by a key selector. For example, with respect to FIG. 11,

var result=e.HoldUntilChanged (IsOdd);

where e is a provided push-based stream corresponding to a push-based stream 1100, result is a resulting push-based stream corresponding to a push-based stream 1102, and IsOdd is a key selector.

Working from left to right, applying IsOdd to a value of 1 from a first notification of push-based stream 1100 generates a boolean value of true and an notification with a value of 1 is generated onto push-based stream 102. Applying IsOdd to a value of 3 from a second notification of push-based stream 1100 generates a boolean value of true, which is a non-distinct contiguous notification as determined by IsOdd with respect to the previous contiguous notification. As a result, no corresponding notification is generated to push-based stream 1102. Applying IsOdd to a value of 4 from a third notification of push-based stream 1100 generates a boolean value of false, which is a distinct contiguous notification as determined by IsOdd with respect to the previous contiguous notification. Therefore, a notification with a value of 4 is generated onto push-based stream 1102. Applying IsOdd to a value of 5 from a fourth notification of push-based stream 1100 generates a boolean value of true, which is a distinct contiguous notification as determined by IsOdd with respect to the previous contiguous notification. Therefore, a notification with a value of 5 is generated onto push-based stream 1102.

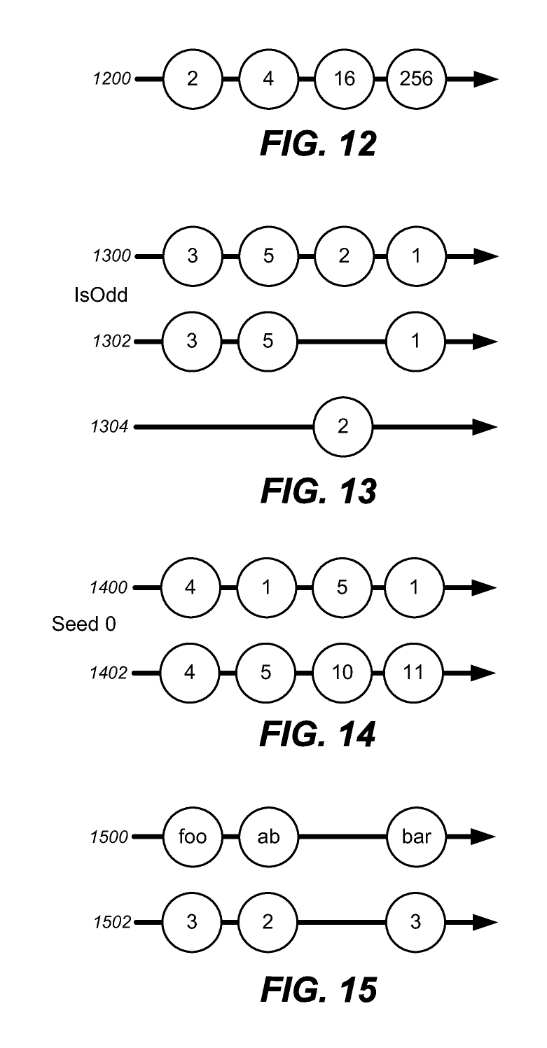

The Iterate operator starts a new thread which fires a current iteration of applying an accumulator function to a current value starting with a seed. For example, with reference to FIG. 12,

var result=notification.Iterate (2, Square);

where result is a resulting push-based stream 1200, 2 is a seed, and Square is the accumulator function.

Working from left to right, a notification with a value of 2 is fired, or generated, to push-based stream 1200. Applying the accumulator function, Square, to the value 2, results in a notification with a value of 4 being generated to push-based stream 1200. Applying the accumulator function, Square, to the value 4, results in a notification with a value of 16 being generated to push-based stream 1200. Applying the accumulator function, Square, to the value 16, results in a notification with a value of 256 being generated to push-based stream 1200 . . . , etc.

The Partition operator partitions notifications from a provided push-based stream into two push-based streams, such that a first push-based stream includes only those notifications from the provided push-based stream for which a predicate is true and a second push-based stream includes only those notifications from the provided push-based stream for which the predicate is false. For example, with reference to FIG. 13,

(result1, result2)=e.Partition (IsOdd);

where e is a provided push-based stream corresponding to a push-based stream 1300, result1 is a first resulting push-based stream corresponding to a push-based stream 1302, result2 is a second resulting push-based stream corresponding to a push-based stream 1304, and IsOdd is a predicate.

Working from left to right, applying the predicate, IsOdd, to a first notification of push-based stream 1300 having a value of 3 results in a boolean value of true and a notification with a value of 3 being generated to push-based stream 1302. Applying the predicate, IsOdd, to a second notification of push-based stream 1300 having a value of 5 results in a boolean value of true and a notification with a value of 5 being generated to push-based stream 1302. Applying the predicate, IsOdd to a third notification of push-based stream 1300 having a value of 2 results in a boolean value of false and a notification with a value of 2 being generated to a push-based stream 1304. Applying the predicate, IsOdd, to a fourth notification of push-based stream 1300 having a value of 1 result in a boolean value of true and a notification with a value of 1 being generated to push-based stream to 1302.

The Prepend operator operates on a provided push-based stream and generates a resulting stream with all of the notifications of the provided push-based stream. For example,

var result=e.Prepend (1, 2);

where result is a resulting push-based stream, e is a provided push-based stream, and 1 and 2 are arguments representing values of notifications that are to be prepended to the resulting push-based stream followed by all of the notifications generated from the provided push-based stream to the resulting push-based stream. The Prepend operator may have a variable number of arguments.

The Range operator starts a new thread which fires notifications within a given range of integer values. For example,

var result=notification.Range (1, 4);

where result is a resulting push-based stream, 1 is a low value of a range and 4 is a number of values to generate. In this example, a resulting push-based stream may be generated with notifications having values of 1, 2, 3 and 4, respectively. In some embodiments, the values may be generated in a different order. For example, the resulting push-based stream may have notifications having values of 3, 1, 4 and 2, respectively, or another order of values.

The Recurse operator may define notifications which fire back upon themselves. The Recurse operator may take one function, which has a notification parameter, and returns a notification. The notification parameter may be equal to a value that is to be returned, such that code, which refers to the notification parameter, refers to the notification itself. For example,

var e=notification.Recurse (x=>notification.Return (1) .Merge (x)); generates a resulting push-based stream, e, by continually executing a function, Return, which, in this example, returns a value of 1, and merges a notification and the value 1 into the resulting push-based stream, e, thereby resulting in the push-based stream, e, being generated with a number of notifications having a value of 1.

The Repeat operator may start a new thread which repeats a specified value. For example,

var result=notification.Repeat (1);

where result is a resulting push-based stream and 1 is a value to be included in notifications to be generated to the resulting push-based stream. In this example, the resulting push-based stream has a number of notifications with a value of 1.

The Scan operator may be provided with a push-based stream, a seed, and an accumulator function. The Scan operator fires a notification with a value of a current accumulation whenever a notification from the provided push-based stream is fired. For example, with reference to FIG. 14,

var result=e.Scan (0, Add);

where e is a provided push-based stream corresponding to a push-based stream 1400, result is a resulting push-based stream corresponding to a push-based stream 1402, 0 is a seed, and Add is an accumulation function.

Working from left to right, adding the seed, 0, to a value of 4 results in a notification with a value of 4 being generated onto resulting push-based stream 1402. Adding a current value, 1, of a second notification of push-based stream 1400 to the accumulation value, 4, results in a notification with a value of 5 being generated onto push-based stream 1402. Adding a current value, 5, of a third notification of push-based stream 1400 to the accumulation value, 5, results in a notification with a value of 10 being generated onto push-based stream 1402. Adding a current value, 1, of a fourth notification of push-based stream 1400 to the accumulation value, 10, results in a notification with a value of 11 being generated onto push-based stream 1402.

The Unzip operator may be provided with a push-based stream and a function to produce pairs for creating two resulting push-based streams, such that a notification with a value of a first member of a pair is generated to a first resulting push-based stream and a notification with a value of a second member of the pair is generated to a second resulting push-based stream. For example, with reference to FIG. 15,

(result1, result2)=e.Unzip (x=>(x, x.Length));

where result1 is a first resulting push-based stream corresponding to a push-based stream 1500, result2 is a second resulting push-based stream corresponding to a push-based stream 1502, and e is a provided push-based stream, not shown, identical to push-based stream 1500.

Working from left to right in this example, a notification with a value of “foo” is generated to push-based stream 1500 and a notification with a value equal to a length of “foo” is generated onto push-based stream 1502. Next, a notification with a value of “ab” is generated to push-based stream 1500 and a notification with a value equal to a length of “ab” is generated onto push-based stream 1502. Lastly, a notification with a value of “bar” is generated to push-based stream 1500 and a notification with a value equal to a length of “bar” is generated onto push-based stream 1502.

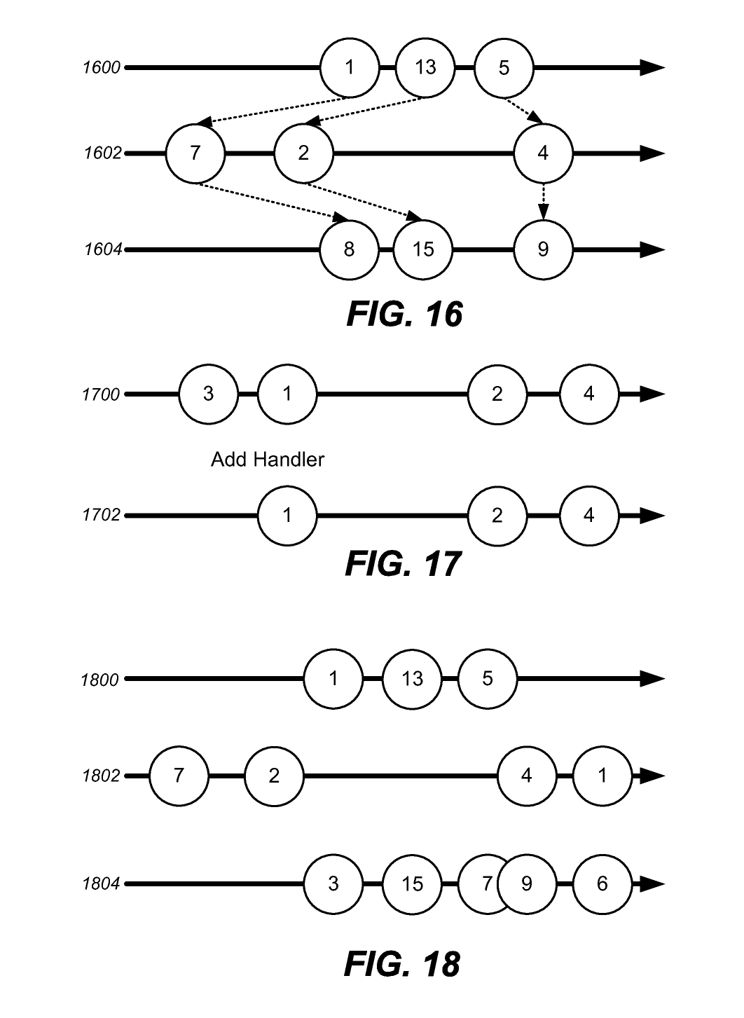

The Zip operator is provided with two push-based streams, pairs notifications from the two push-based streams, orderwise, and fires a notification to a resulting push-based stream with a value derived from applying a given selector function to values from the pair of notifications. For example, with reference to FIG. 16,

var result=e1.Zip (e2, Add);

where result is a resulting push-based stream corresponding to a push-based stream 1604, e1 is a first provided push-based stream corresponding to a push-based stream 1600. e2 is a second provided push-based stream corresponding to a push-based stream 1602.

Working from left to right in this example, a first notification of push-based stream 1600 with a value of 1 is paired with a first notification of push-based stream 1602 with a value of 7 resulting in a notification with a value of 8 (applying the selector function, Add, to the values 1 and 7) being generated to push-based stream the 1604. A second notification of push-based stream 1600 with a value of 13 is paired with a second notification of push-based stream 1602 with a value of 2 resulting in a notification with a value of 15 (applying the selector function, Add, to the values 13 and 2) being generated to push-based stream the 1604. A third notification of push-based stream 1600 with a value of 5 is paired with a third notification of push-based stream 1602 with a value of 4 resulting in a notification with a value of 9 (applying the selector function, Add, to the values 5 and 4) being generated to push-based stream the 1604.

### Time Operators

In an embodiment consistent with the subject matter of this disclosure, Time operators may include a Delay operator, an Occurred operator, a Sample operator, a Sleep operator, a Throttle operator, a Timeout operator and a Timer operator.

The Delay operator may delay a generation of each notification of a resulting push based stream by n milliseconds, where n is a positive integer For example,

var result=e.Delay (100);

where result is a resulting push-based stream and 100 is a number of time units, milliseconds in this example, to delay before generating a notification to the resulting push-based stream. Therefore, in this example, for each notification of a provided push-based stream, e, a delay of 100 milliseconds occurs before generating a corresponding notification to the resulting push-based stream. In other embodiments, the time units may be in seconds or another time unit.

The Occurred operator may create a resulting push-based stream which fires one notification with a boolean value. If a first notification of a provided push-based stream arrives within a given number of time units, a notification with a boolean value of true may be fired. Otherwise, a notification with a boolean value of false may be fired. For example,

var result=e.Occurred (250);

where result is a resulting push-based stream, e is a provided push-based stream and 250 is a number of time units, milliseconds in this example. Therefore, in this example, if a first notification of the provided push-based stream arrives within 250 millisecond then a notification with a boolean value of true is generated to the resulting push-based stream. Otherwise, a notification with a boolean value of false is generated to the resulting push-based streams. In other embodiments, the time units may be in seconds or another time unit.

The Sample operator may fire a last notification that occurred during a current time interval from a provided push-based stream to a resulting push-based stream every n time units, where n is a positive integer. The time units may be in milliseconds or another unit of time. For example,

var result=e.Sample (250);

where result is a resulting push-based stream, e is a provided push-based stream and 250 is a number of time units, milliseconds in this example. Therefore, in this example, every 250 millisecond time interval a last notification that occurred during the time interval is fired onto the resulting push-based stream.

For each respective notification of a given push-based stream, the Sleep operator may cause a processing device to sleep for a given number of time units on a thread which raised a respective notification before firing the respective notification. The time units may be in milliseconds. In other embodiments, the time units may be in another unit of time. For example,

var result=e.Sleep (100);

where e is a provided push-based stream and 100 is a number of time units to sleep, milliseconds in this example. Therefore, in this example, when a notification occurs on the given push-based stream, a processing device on which the library of operators is implemented may sleep for 250 millisecond on a thread which raised the notification before firing the notification.

Given a push-based stream, the Throttle operator may only fire a notification if after n time units another notification has not been fired on the given push-based stream. The time units may be in milliseconds. In other embodiments, the time units may be in another unit of time. For example,

var result=e.Throttle (250);

where e is a provided push-based stream and 250 is a number of time units, milliseconds in this example. Therefore, in this example, when a notification has not fired on the given push-based stream for 250 milliseconds, a notification is fired. The fired notification may have a value equal to a value of a last notification that occurred on the provided push-based stream.

For a given push-based stream, the Timeout operator may return the push-based stream if a notification occurs on the given push-based stream within n time units, where n is a positive integer. If the notification does not occur on the given push-based stream within n time units, then the Timeout operator throws a timeout exception in the push-based stream. The time units may be in milliseconds. In other embodiments, the time units may be in another unit of time. For example,

var result=e.Timeout (250);

where e is a provided push-based stream and 250 is a number of time units for a timeout, milliseconds in this example. Therefore, in this example, when a first notification occurs on the given push-based stream within 250 milliseconds, the provided push-based stream may be returned. Otherwise, a timeout exception may be thrown in the push-based stream.

The Timer operator may create a push-based stream in which a first notification occurs after n time units and each subsequent notification occurs m time units after each immediately preceding notification. The time units may be in milliseconds. In other embodiments, the time units may be in another unit of time. For example,

var result=Event.Timer (100, 250);

where result is a resulting push-based stream and 100 and 250 are time units, milliseconds in this example. According to this example, the resulting push-based stream fires a first notification after 100 milliseconds and fires subsequent notifications 250 milliseconds after each immediately preceding notification is fired.

### Push-Based Operators

In an embodiment consistent with the subject matter of this disclosure, push-based operators may include a CacheValue operator, a CallCC operator, an Amb operator, a Latch operator, a Memoize operator, a Merge operator and a Toggle operator.

Given a provided push-based stream, the CacheValue operator creates a new push-based stream, which is not lazy, and caches a last notification on the provided push-based stream so that when a handler is added to process notifications of the new push-based stream, the last notification may be fired onto the new push-based stream before the remaining notifications of the provided push-based stream are fired onto the new push-based stream. For example, with reference to FIG. 17,

var result=e.CacheValue ( );

where result is a new push-based stream corresponding to a push-based stream 1702 and e is a push-based stream corresponding to provided push-based stream 1700.

Working from left to right, a first notification with a value of 3 occurs on provided push-based stream 1700, but is cached because a handler has not yet been added to process notifications from push-based stream 1702. After adding a handler, the first notification with the value of 3 is fired onto push-based stream 1702 and a second notification with a value of 1 from push-based stream 1700 is fired onto push-based stream 1702. Each subsequent notification occurring on push-based stream 1700 is fired onto push-based stream 1702.

Given multiple provided push-based stream, the Amb operator creates a new push-based stream which is identical to a first one of the multiple provided push-based streams to fire a notification. For example,

var result=e1.Amb (e2);

where result is a new push-based stream, e1 is a first provided push-based stream, and e2 is a second provided push-based stream. In some embodiments, more than two push-based streams may be provided, such that a new push-based stream may be created which is identical to a first one of the more than two provided push-based streams to fire a notification.

Given two provided push-based streams, every time a notification fires on one of the two push-based streams, the Latch operator causes a last known notification from each of the provided push-based streams to be taken (if the respective push-based streams have a last known notification), invokes a selector function, and fires a result as a notification in a resulting push-based stream. For example, with reference to FIG. 18,

var result=e1.Latch (e2, Add);

where result is a resulting push-based stream corresponding to a push-based stream 1804, e1 and e2 are provided push-based streams corresponding to a push-based stream 1800 and a push-based stream 1802, respectively, and Add is a selector function.

Working from left to right, a first and a second notification with respective values of 7 and 2 occur on push-based stream 1802, but because a notification had not yet occurred on push-based stream 1800, no notification is generated onto push-based stream 1804. Next, a first notification with a value of loccurs on push-based stream 1800. Last known notifications on push-based streams 1800 and 1802 are notifications with a value of 1 and 2, respectively. Applying the selector function, Add, to the values 1 and 2 results in a notification with a value of 3 being fired onto resulting push-based stream 1804. In other embodiments, more than two push-based streams may be provided for a Latch operator.

Given a provided push-based stream, the Memoize operator creates a new push-based stream, which is not lazy, and caches a first notification that fires on the provided push-based stream. All other notifications are ignored. When a handler is added to process notifications on the provided push-based stream, the cached notification is fired onto a resulting push-based stream (if there is a cached notification). Otherwise, if there is no cached notification, then a first notification that occurs on the provided push-based stream will be fired onto the resulting push-based stream. For example,

var result=e.Memoize ( );

where result is a resulting push-based stream and e is a provided push-based stream.

The Merge operator is provided with multiple push-based streams and creates a resulting push-based stream on which a notification is fired for each notification occurring on any of the provided multiple push-based streams. For example,

var result=e1.Merge (e2)

where result is a resulting push-based stream and e1 and e2 are multiple provided push-based streams. Although the above example has only two provided push-based streams, the Merge operator may be used with more than two provided push-based streams.

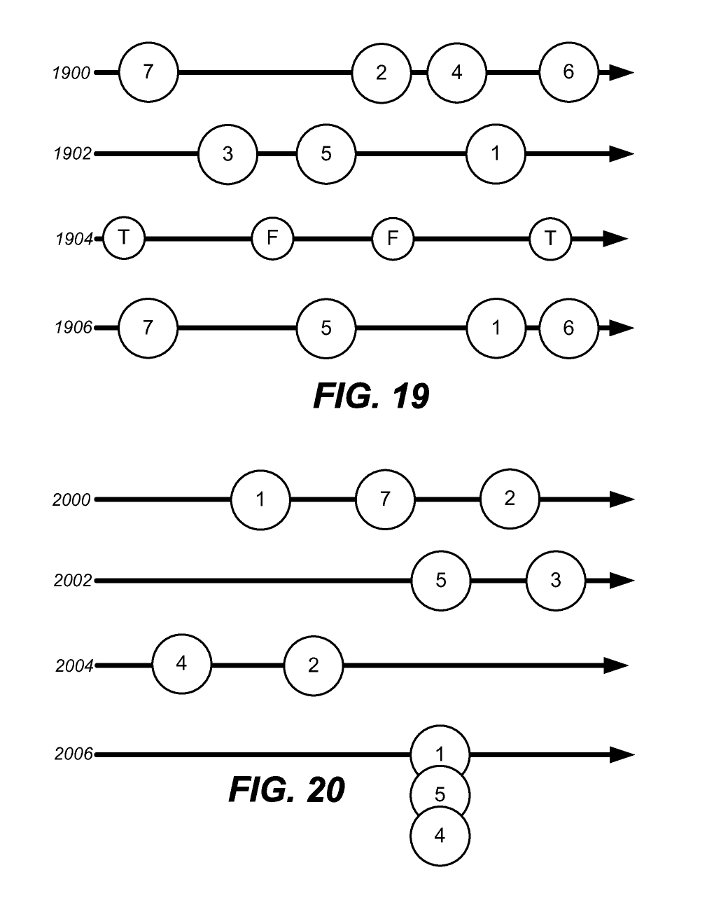

Given two provided push-based streams and a toggle source, which is a notification stream of boolean values, the Toggle operator creates a resulting push-based stream in which a notification from a first provided push-based stream fires onto the resulting push-based stream if the toggle is true. If the toggle is false, a notification from a second provided push-based stream fires onto the resulting push-based stream. For example, with reference to FIG. 19,

var result=e1.Toggle (e2, toggle);

where result is a resulting push-based stream corresponding to a push-based stream 1906, e1 and e2 are provided push-based streams corresponding to a push-based stream 1900 and a push-based stream 1902, respectively, and toggle is a toggle source corresponding to 1904.

Working from left to right, a first notification with a value of 7 occurs on push-based stream 1900 while toggle source 1904 is true. As a result, the first notification of push-based stream 1900 is fired onto push-based stream 1906. Next, a first notification with a value of 3 occurs on push-based stream 1902. However, because toggle source of 1904 is false, the first notification of push-based stream 1902 is not fired onto push-based stream 1906. Next, a second notification with a value of 5 occurs on push-based stream 1902. However, toggle source 1904 is now false. Therefore, the second notification of push-based stream 1902 is fired onto push-based stream 1906. A second and third notification with a respective values of 2 and 4 occur on push-based stream 1900. At this point, toggle source 1904 is false. As a result, no notification is fired onto push-based stream 1906. Next, a third notification with a value of 1 occurs on push-based stream 1902. Toggle source of 1904 is false. As a result, the third notification on push-based stream 1902 is fired onto push-based stream 1906. A fourth notification with a value of 6 occurs on push-based stream 1900. Because toggle source 1904 is now true, the fourth notification on push-based stream 1900 is fired onto push-based stream 1906.

### Asynchronous Operators

In an embodiment consistent with the subject matter of this disclosure, asynchronous operators may include a Parallel operator, a Series operator, a Start operator, a ToAsync operator, a Wait operator and a WaitOne operator.

Provided with multiple push-based streams, the Parallel operator creates a resulting push-based stream which fires with a first notification from each of the multiple push-based streams once all of the multiple push-based streams have fired at least one notification. For example, with respect to FIG. 20,

var xs=e1.Parallel (e2, e3);

where xs is a resulting push-based stream corresponding to push-based stream 2006 and e1, e2 and e3 are provided multiple push-based streams corresponding to push-based streams 2000, 2002 and 2004.

Working from left to right, a first notification with a value of 4 occurs on push-based stream 2004. Next, a first notification with a value of 1 occurs on push-based stream 2000. A second notification with a value of 7 occurs on push-based stream 2000. Next, a first notification with a value of 5 occurs on push-based stream 2002. At this point, each of the provided multiple push-based streams 2000, 2002 and 2004 have fired a notification. As result, notifications with respective values of 1, 5 and 4, corresponding to first notifications of push-based streams 2000, 2004 and 2006, are fired onto push-based stream 2006.

Provided with multiple push-based streams, the Series operator creates a first resulting push-based stream which adds a handler to the first of the multiple push-based streams. Once a notification occurs on the first of the multiple push-based streams, the handler is added to the second push based stream. Once a notification occurs on the second push based stream, the handler is added to the third push-based stream, and so on. Once all of the multiple push based streams have fired a notification, a notification is fired onto a resulting push-based stream with first notifications from the multiple push-based streams. For example, with respect to FIG. 21,

var xs=e1.Series (e2, e3);

where xs is a resulting push-based stream corresponding to a push-based stream 2106 and e1, e2 and e3 are provided multiple push-based streams corresponding to push-based streams 2100, 2102 and 2104.

Working from left to right, 2106 is created and a handler is added to push-based stream 2100. A first notification with a value of 1 occurs on push-based stream 2104 and the handler is added to push-based stream 2102. A first notification with a value of 5 occurs on push-based stream 2102 and the handler is added to push-based stream 2104. A notification with a value of 4 occurs on push-based stream 2104. Because all of the provided multiple push-based streams 2100, 2102 and 2104 have fired a notification, notifications corresponding to first notifications of the provided multiple push-based streams 2100, 2102 and 2104 are fired onto resulting push-based stream 2106.

Although the above example is illustrated with three provided push-based streams, in some embodiments, the series operator may have fewer than three provided push-based streams or more than three provided push-based streams.

The Start operator causes a given function to be immediately executed and returns a push-based stream which fires a notification when the given function completes. The notification may have a value equal to a return value of the given function. For example,

var result=notification. Start (F);

where result is the push-based stream to be returned and F is the given function, causes the function F to be immediately executed. When the function F completes and returns a value, a notification with a value equal to the returned value may be fired onto the push-based stream to be returned.

The ToAsync operator converts an asynchronous function or a begin/end pair to an asynchronous function which returns a push-based stream with a notification. For example,

var f=Event.ToAsync (F);

where f is a returned push-based stream with a notification and F is a given asynchronous function or a begin/end pair.

The Wait operator starts a notification computation for a provided push-based stream and waits for a first n notifications to occur on the provided push-based stream, where n is a positive integer, after which an array with the first n notifications is returned. For example,

var xs=e.Wait (3);

where xs is a variable representing the array to be returned, e is the provided push-based stream, and 3 indicates that the Wait operator is to wait for the first 3 notifications to occur on the provided push-based stream before returning the array.

The WaitOne operator starts a notification computation for a provided push-based stream and waits for a first notification, after which a value of the first notification is returned. For example,

var x=e.WaitOne ( );

where x is a variable representing the value of the first notification to be returned and e is the provided push-based stream.

### Exception Operators

In an embodiment consistent with the subject matter of this disclosure, exception operators may include a Catch operator, a Throw operator, a TryCatch operator, a Dematerialize operator and a Materialize operator.

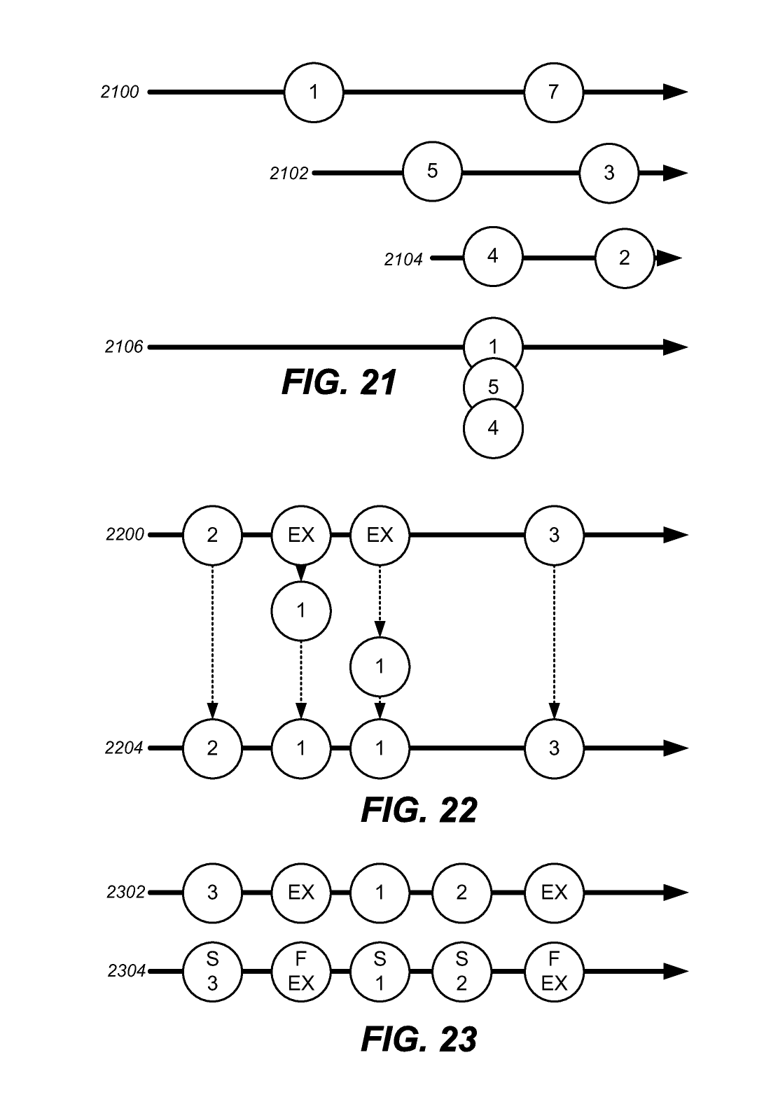

For each successful notification of a provided push-based stream, the Catch operator causes the notification to be refired onto a resulting push-based stream. For each exception, the Catch operator causes a function to be executed which returns a second push based stream which is flattened into the resulting push-based stream. For example, with reference to FIG. 22,

var result=e.Catch (ex=>Event.Return (1));

where result is a resulting push-based stream corresponding to a push-based stream 2202, Return is a function to be executed when an exception occurs, and e is a provided push-based stream.

Working from left to right, a first successful notification with a value of 2 occurs on push-based stream 2202. The Catch operator causes the first successful notification to be refired onto resulting push-based stream 2204. Next, a first exception occurs on push-based stream 2202 and the Catch operator executes a function, in this example Return (1), which returns a value of 1, which is then flattened into resulting push-based stream 2204. A second exception occurs on push-based stream 2202 and the Catch operator executes the function, Return (1), which returns the value of 1, which is again flattened into resulting push-based stream 2204. Finally, a second successful notification with a value of 3 occurs on provided push-based stream 2202 and the Catch operator refires the second successful notification onto resulting push-based stream 2204.

The Throw operator causes a push-based stream to be created which has an exception. For example,

var result=Event.Throw (ex);

where result is a resulting push-based stream to be created.

The TryCatch operator adds a successful handler to a provided push-based stream to process successful notifications and adds a failure handler to the provided push-based stream to process failed notifications. For example,

var remove=e.TryCatch (Success, Fail);

where e is a provided push-based stream, Success is a handler for processing successful notifications that occur on the provided push-based stream, and Fail is a handler for processing failed notifications that occur on the provided push-based stream.

The Dematerialize operator transforms each successful notification or failed notification that occurs on the provided push-based stream into a success with a value or a failure with an exception, respectively. For example, with reference to FIG. 23,

var result=e.Dematerialize ( );

where result is a resulting push-based stream corresponding to a push-based stream 2304 and e is a provided push-based stream corresponding to a push-based stream 2302.

Working from left to right, a successful notification with a value of 3 occurs on push-based stream 2302. The Dematerialize operator causes a notification to be fired onto push-based stream 2304 indicating a success and a value of 3. Next, an exception occurs on push-based stream 2302 and the Dematerialize operator causes a notification to be fired onto push-based stream 2304 indicating a failure with an exception. A successful notification with a value of 1 occurs on push-based stream 2302 and the Dematerialize operator causes a notification to be fired onto push-based stream 2304 indicating a successful notification with a value of 1. A successful notification with a value of 2 occurs on push-based stream 2302 and the Unwrap operator causes a notification to be fired onto push-based stream 2304 indicating a successful notification with a value of 2. Finally, an exception occurs on push-based stream 2302 and the Dematerialize operator causes a notification to be fired onto push-based stream 2304 indicating a failure with an exception.

The Materialize operator performs a reverse operation with respect to the Dematerialize operator. Provided with a push-based stream of notifications with indications of a successful notification or a failed notification and respective values or exceptions, the Materialize operator transforms the provided push-based stream into a resulting push-based stream of values or exceptions. With respect to FIG. 23, if push-based stream 2304 is a provided push-based stream, then the Materialize operator fires corresponding notifications onto resulting push-based stream 2302. For example,

var result=e.Materialize ( );

where result is a resulting push-based stream and e is a provided push-based stream. Notifications having indications of a success and a value are transformed and fired onto the resulting push-based stream as notifications with a value. Notifications having indications of a failure and an exception are fired onto the resulting push-based stream as exceptions.

### Functional Operators

In an embodiment consistent with the subject matter of this disclosure, functional operators may include a Defer operator and a Let operator.

The Defer operator is provided with a function which returns a notification. The Defer operator causes execution of the provided function to be deferred until a handler is added to process notifications on a provided push-based stream and causes re-execution of the function for each handler that is added to the provided push-based stream. For example,

var e=Defer (( )=>Event.Start (F));

where e is a provided push-based stream, Start is an operator to start a function, F is the function, and Defer causes the start of the function F to be deferred until a handler is added to process notifications on provided push-based stream e.

The Let operator gives a name to a notification on a provided push-based stream. For example,

e.Let (x=>f (x));

where e is a push-based stream. The above code binds x, which is a notification on push-based stream e to e. The above code is equivalent to “f (e);”. The Let operator enables a user to refer to a large preceding expression by using a much simpler name.

### Context Operators

In an embodiment consistent with the subject matter of this disclosure, context operators may include a RunOnEventLoop operator, a RunOnNewThread operator, a RunOnScheduler operator, a RunOnSynchronizationContext operator, a RunOnThreadPool operator and a RunOnUIThread operator.

In general a “context” encapsulates some kind of “state”. The above-mentioned context operators change the context to a respective particular context. As an example, in some operating systems, including but not limited to Windows® (Windows is a registered trademark of Microsoft Corporation of Redmond, Wash.) operating systems provided by Microsoft Corporation of Redmond, Wash., certain operations may be performed only in a particular context/thread.

The RunOnEventLoop operator causes a notification processing context to change to a notification or event loop. The event loop serializes all notifications. A format of the operator is

var result=e.RunOnEventLoop (eventLoop);

where e refers to a provided push-based stream and eventLoop refers to a particular eventLoop.

The RunOnNewThread operator causes a notification processing context to change to a new thread. The RunOnNewThread operator spawns a new thread for each notification on a provided push-based stream. A format of the operator is

var result=e.RunOnNewThread ( );

where e refers to a provided push-based stream.

The RunOnScheduler operator causes a notification processing context to change to a scheduler, which may determine a context in which to perform notification or event processing. A format of the operator is

var result=e.RunOnNewThread ( );

where e refers to a provided push-based stream.

The RunOnSynchronizationContext operator causes a notification processing context to change to another context via a synchronization context. A format of the operator is

var result=e.RunOnSynchronizationContext (context);

where e refers to a provided push-based stream and context refers to a new context to which the notification or event processing is to change.

The RunOnThreadPool operator causes a notification processing context to change to a thread in a thread pool. A format of the operator is

var result=e.RunOnThreadPool ( );

where e refers to a provided push-based stream.

The RunOnUIThread operator causes a notification processing context to change to a User Interface (UI) thread. A format of the operator is

var result=e.RunOnUIThread ( );

where e refers to a provided push-based stream.

### Event Specific Operators

In an embodiment consistent with the subject matter of this disclosure, event-specific operators may include a Subscribe operator, a GetEvent operator, an OnRemove operator, a Run operator, a RunOne operator, a Share operator, a ToBufferedEnumerable operator, a ToEnumerable operator and a ToObservable operator.

The Subscribe operator causes a handler to be added to process events or notifications from a push-based stream. The Subscribe operator also causes unhandled exceptions to be thrown. A format of the operator is

var remove=e.Subscribe (Handler);

where e refers to a provided push-based stream and Handler refers to a particular handler for processing notifications on push-based stream e.

The GetEvent operator causes an existing notification of one type to be converted to a push-based notification. In one embodiment, the existing notification of one type may be a .Net notification (the .Net framework is available from Microsoft Corporation of Redmond, Wash.). For example,

var result=control.GetEvent<EventArgs>(“TextChanged”);

where Event refers to an existing notification and EventArgs refers to arguments of the GetEvent operator. The above exemplary code converts the existing notification to a push-based notification called TextChanged. The following code

| var result = Event.GetEvent <EventArgs> (h => | |
|---|---|
| | control.TextChanged += h, |
| | h => control.TextChanged −= h); |

defines how to add a handler for processing the push-based notification and how to remove the handler.

The OnRemove operator adds code that is to be executed whenever a handler is removed from an event or notification source, such as a push-based stream. For example,

var result=e.OnRemove (F);

where e is a provided push-based stream and F is the code to be executed whenever a handler is removed from processing notifications of the push-based stream.

The Run operator starts an event or notification computation. If an exception occurs, the exception is wrapped and thrown in a current context. The notification computation may be stopped by invoking a remove function. For example,

var remove=e.Run ( );

where e is a provided push-based stream and remove is a function that may be invoked to stop the notification computation. The Run operator starts a notification computation with respect to a notification for the push-based stream e.

The RunOne operator starts a notification computation in a situation in which at most one notification is to be processed. All other aspects of the RunOne operator are identical to the Run Operator. For example,

var remove=e.RunOne ( );

where e is a provided push-based stream and remove is a function that may be invoked to stop the notification computation. RunOne starts a notification computation with respect to only one notification for the push-based stream e.

Given a push-based stream, the ToBufferedEnumerable operator causes the push-based stream to be converted to a pull-based stream. For each notification that is fired in the pull-based stream, the notification is stored in a buffer. When a routine to obtain a next notification is called, such as, for example, MoveNext, a next notification is obtained from the buffer or the routine is blocked until the buffer has a notification stored therein. The following is an example of use of the ToBufferedEnumerable operator,

var en=ev.ToBufferedEnumerable ( );

where en is a resulting pull-based stream and ev is a provided push-based stream.

The ToEnumerable operator is similar to the ToBufferedEnumerable operator. However, the ToEnumerable operator does not buffer a notification fired in a given pull-based stream. That is, when a notification occurs on a provided push-based stream the ToEnumerable operator stores the notification as a latest notification. When a routine, such as, for example, MoveNext, is called, the stored latest notification is returned. If there is no stored latest notification when the routine is called, the routine is blocked until there is a stored latest notification. The following is an example of use of the ToEnumerable operator,

var en=ev.ToEnumerable ( );

where en is a resulting pull-based stream and ev is a provided push-based stream.

The ToObservable operator causes a new thread to be created which enumerates an enumerable. That is, the ToObservable operator converts events or notifications from a provided pull-based stream to push-based notifications on a new thread. Whenever a routine, such as, for example, MoveNext, is called to obtain a latest pull-based notification from the new thread, the routine returns with a latest notification. When the routine does return, a notification is fired on the provided push-based stream. If the latest notification does not exist, then the routine is blocked until the latest notification does exist. The following is an example of use of the ToObservable operator,

var en=ev.ToObservable ( );

where en is a resulting push-based stream and ev is a provided pull-based stream.

### Miscellaneous

The above-mentioned operators and associated formats and examples are only exemplary. In other embodiments consistent with the subject matter of this disclosure, operators may have different names, may have different types of arguments, may have a different number of arguments, may produce different types of outputs, may have different formats, may use different selector functions and element functions, may use different and/or may perform different functions. Further, exemplary formats of the above-mentioned operators provided in this application are coded using LINQ. However, in other embodiments, the formats of the operators may be coded in XLINQ, C#, or other languages.

### CONCLUSION

Embodiments consistent with the subject matter of this disclosure provide a library of operators for performing operations upon events or notifications of push-based streams. As a result, many of the difficulties that software developers currently experience when developing code for processing asynchronous, push-based, observable events or notifications have been diminished or eliminated.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Accordingly, the appended claims and their legal equivalents define embodiments, rather than any specific examples given.

We claim as our invention:

1. A method in a computing device for using a library to compose and orchestrate computations regarding push-based streams, the method comprising:
using a plurality of operators of the library to perform operations on at least one of the push-based streams, the plurality of operators being selected from a group consisting of standard sequence operators, other sequence operators, time operators, asynchronous operators, exception operators, push-based operators, context operators, event-specific operators and functional operators, wherein
the method is implemented in the computing device.

2. The method of claim 1, wherein the standard sequence operators comprise at least one operator selected from a group consisting of:
a first operator that generates a first resulting push-based stream from a first provided push-based stream by ensuring that at most one notification is generated for the first resulting push-based stream for each distinct key value of notifications of the first provided push-based stream;
a second operator that generates a plurality of second resulting push-based streams, each of the resulting plurality of second resulting push-based streams including a respective equivalence class of one or more notifications as determined by a key selector operating on notifications of a second provided push-based stream;
a third operator that generates notifications of a third resulting push-based stream based on notifications occurring in each of a plurality of third provided push-based streams having a particular relationship with each other;
a fourth operator that generates a fourth resulting push-based stream based on notifications of a fourth provided push-based stream occurring after a firing of a given number of the notifications of the fourth provided push-based stream;
a fifth operator that generates a fifth resulting push-based stream based on notifications of a fifth provided push-based stream while skipping ones of the notifications of the fifth provided push-based stream that occur before a first notification of the fifth provided push-based stream that has a value satisfying a given predicate;
a sixth operator that generates notifications of a sixth resulting push-based stream based on notifications occurring in a sixth provided push-based stream until a value of a notification occurring in the sixth provided push-based stream fails to satisfy a second given predicate; and
a seventh operator that generates a seventh resulting push-based stream having notifications with values of notifications from any one of a plurality of seventh provided push-based streams, such that no two notifications of the generated seventh resulting push-based stream have a same value.

3. The method of claim 1, wherein the other sequence operators comprise at least one operator selected from a group consisting of:
a first operator that produces a first resulting push-based stream based on a current notification of a first provided push-based stream and an immediately preceding notification of the current notification;
a second operator that generates a plurality of second resulting push-based streams, each of the resulting plurality of second resulting push-based streams including a respective equivalence class of one or more notifications as determined by a key selector operating on notifications of a second provided push-based stream until a notification of the second provided push-based stream is determined to be in a different equivalence class than an immediately preceding notification of the second provided push-based stream;
a third operator that generates a third resulting push-based stream based on notifications of a third provided push-based stream with non-distinct contiguous notifications, as determined by a key selector, removed;
a fourth operator that partitions a fourth provided push-based stream into a plurality of fourth resulting push-based streams, such that a first fourth resulting push-based stream includes only notifications from the fourth provided push-based stream for which a given predicate is true and a second fourth resulting push-based stream includes only notifications from the fourth provided push-based stream for which the given predicate is false;
a fifth operator that generates a fifth resulting push-based stream based on prepending one or more specified values to notifications of a fifth provided push-based stream;
a sixth operator that generates a sixth resulting push-based stream having notifications with values based on a provided range of integer values; and
a seventh operator that generates a seventh resulting push-based stream having notifications with respective values equal to a value of an accumulation function at a time when each of the notifications of the seventh resulting push-based stream are fired.

4. The method of claim 1, wherein the time operators comprise at least one operator selected from a group consisting of:
a first operator that delays generating each notification of a first resulting push-based stream by a given number of time units;
a second operator that fires a second resulting push-based stream with a boolean value, the boolean value being true when a first notification of a given push-based stream arrives within a given number of time units, otherwise the boolean value being false;
a third operator that generates a third resulting push-based stream based on a sampling of notifications of a provided push-based stream every given number of times units;
a fourth operator that generates notifications of a fourth resulting push-based stream based on notifications of a second provided push-based stream only when a notification of the second provided push-based stream has not been fired for a second given number of time units; and
a fifth operator that generates a first notification of a fifth resulting push-based stream after a third given number of time units and each one of remaining notifications after each respective fourth given number of time units.

5. The method of claim 1, wherein the push-based operators comprise at least one operator selected from a group consisting of:
a first operator that generates a first resulting push-based stream and caches a last notification of the first resulting push-based stream such that a later-added handler will fire the last notification before firing remaining notifications of the first resulting push-based stream;
a second operator that generates a second resulting push-based stream that is identical to one of a plurality of provided push-based streams to fire a notification first;
a third operator that generates a notification of a second resulting push-based stream by taking a last known notification from each of a plurality of second provided push-based streams when one of the plurality of second provided push-based streams fires a notification, and invokes a given selector function; and
a fourth operator that generates a third resulting push-based stream which fires a notification for each notification of a plurality of third provided push-based streams.

6. The method of claim 1, wherein the asynchronous operators comprise at least one operator selected from a group consisting of:
a first operator that generates a first resulting push-based stream which fires a first notification from each of a plurality of first provided push-based streams when all of the plurality of first provided push-based streams have fired at least one notification;
a second operator that creates a second resulting push-based stream and adds a handler to a first one of a plurality of second provided push-based streams, when a notification fires on the first one of the plurality of second provided push-based streams a second handler is added to a second one of the plurality of push-based streams, when a notification fires on the second one of the plurality of second provided push-based streams a third handler is added to a third one of the plurality of push-based streams, after all of the plurality of second provided push-based streams have fired respective notifications a notification is fired in the second resulting notification stream, the notification of the second resulting notification stream including first notifications of each of the plurality of second provided push-based streams;
a third operator that starts executing a given function and returns a third resulting push-based stream when the function completes with a return value;
a fourth operator that converts a first asynchronous function to a second asynchronous function which returns a fourth resulting push-based stream; and
a fifth operator that starts a notification computation for a notification source, waits for a firing of a given number of notifications from the notification source, and then returns an array including the given number of notifications.

7. The method of claim 1, wherein the exception operators comprise at least one operator selected from a group consisting of:
a first operator that fires a notification on a first resulting push-based stream for each successful value of a notification of a first provided push-based stream, and for each exception of the first provided push-based stream executes a function that returns a second resulting push-based stream and flattens the second resulting push-based stream into the first resulting push-based stream;
a second operator that invokes a given failure handler when an exception is thrown by a given success handler;
a third operator that, for each notification of a second provided push-based stream, generates respective notifications of a second resulting push-based stream, such that for each successful notification of the second provided push-based stream a notification indicating success with a value is generated on the second resulting push-based stream, and for each failed notification of the second provided push-based stream a notification indicating a failure with an exception is generated on the second resulting push-based stream; and
a fourth operator that operates on the a third provided push-based stream having respective notifications of either a success or a failure and generates a notification with a respective value on a third resulting push-based stream for each of the success notifications and a respective exception for each of the failure notifications.

8. A computing device comprising:
at least one processor; and
a storage device accessible by the at least one processor, the storage device comprising a library having instructions for the at least one processor to compose and orchestrate computations regarding push-based streams, the library including a plurality of operators for performing operations on at least one of the push-based streams, the plurality of operators being selected from a group consisting of standard sequence operators, other sequence operators, time operators, asynchronous operators, exception operators, push-based operators, context operators, event-specific operators and functional operators.

9. The computing device of claim 8, wherein the functional operators comprise at least one operator selected from a group consisting of:
a first operator that defers executing a function, which returns a notification, until a handler is added to process the returned notification; and
a second operator that gives a notification a provided name.

10. The computing device of claim 8, wherein the context operators change a context for processing notifications occurring in a push-based stream.

11. The computing device of claim 10, wherein the context includes at least one item from a group consisting of an event loop context, a new thread context, a scheduler context, a synchronization context, a thread in a pool of threads, and a user interface thread.

12. The computing device of claim 8, wherein the notification-specific operators include at least one item from a group consisting of:
a first operator to add a first handler to process notifications of a provided push-based stream and to throw unhandled exceptions;
a second operator to convert an existing notification to a push-based notification;
a third operator to add code to be executed whenever a handler is removed from a push-based stream;
a fourth operator to start execution of a notification computation, when an exception occurs, the exception is wrapped and fired in a current executing context;
a fifth operator to convert notifications of a second provided push-based stream to notifications of a resulting pull-based stream; and
a sixth operator to convert a pull-based stream to a push-based stream.

13. The computing device of claim 8, wherein the standard sequence operators include at least one item from a group consisting of:
a first operator that filters each value of notifications in a provided push-based stream when a given predicate is false;
a second operator that fires a given number of notifications of a second provided push-based stream to produce a resulting push-based stream;
a third operator that generates a plurality of resulting push-based streams based on notification values of a third provided push-based stream; and
a fourth operator that generates a second resulting push-based stream based on notifications of a plurality of provided push-based streams.

14. A tangible machine-readable medium having stored therein instructions for at least one processor of a computing device to perform actions associated with a plurality of operators included in a library for composing and orchestrating computations regarding push-based streams, the plurality of operators comprising:
a plurality of standard sequence operators for performing operations including:
generating a resulting push-based stream based on distinct values of notifications in a provided push-based stream,
grouping values of notifications of a second provided push-based stream into a plurality of second resulting push-based streams based on a key selector, each of the plurality of second resulting push-based streams having only values of notifications in a respective equivalence class,
grouping values of notifications of a plurality of third provided push-based streams into a third resulting push-based stream, such that values of notifications in the third resulting push-based stream are an intersection of the values of the notifications of the plurality of third provided push-based streams, and
grouping values of notifications of a plurality of fourth provided push-based streams into a fourth resulting push-based stream, such that values of notifications in the fourth resulting push-based stream are a union of the values of the notifications of the plurality of fourth provided push-based streams.

15. The tangible machine-readable medium of claim 14, wherein the plurality of operators further comprise:
a plurality of time operators for performing operations including:
delaying generation of each notification of a resulting push-based stream by a given number of time units,
generating a second resulting push-based stream based on notifications of a provided push-based stream, such that when a notification of the provided push-based stream arrives within a second given number of time units a notification having a boolean value of true is generated for the second resulting push-based stream, and when the notification of the provided push-based stream does not arrive within the second given number of time units a notification having a boolean value of false is generated for the second resulting push-based stream,
generating a third resulting push-based stream based on notifications of a second provided push-based stream, such that for each of the notifications of the second provided push-based stream a delay of a third given number of time units occurs before generating a corresponding notification of the third resulting push-based stream, and
generating a fourth resulting push-based stream identical to a third provided push-based stream when a notification occurs on the third provided push-based stream within a given time limit.

16. The tangible machine-readable medium of claim 15, wherein the plurality of operators further comprise:
a plurality of notification-specific operators for performing operations including:
adding a handler to process notifications of a provided push-based stream and to throw unhandled exceptions,
converting an existing non-push-based notification to a push-based notification,
starting execution of a notification computation, and
converting a pull-based notification to a pull-based notification.

17. The tangible machine-readable medium of claim 16, wherein the plurality of operators further comprise:
a plurality of context operators for performing operations including:
changing a context for notification processing to an event loop context,
changing the context for the notification processing to a new thread,
changing the context for the notification processing to a scheduler,
changing the context for the notification processing via a synchronization context,
changing the context for the notification processing to a thread in a thread pool, and
changing the context for the notification processing to a user interface thread.

18. The tangible machine-readable medium of claim 16, wherein the plurality of operators perform actions comprising:
generating respective notifications of a resulting push-based stream based on a current notification of a provided push-based stream and an immediately preceding notification of the provided push-based stream,
executing a side-effecting function for each notification in a second provided push-based stream using a respective value of each of the notifications as a parameter of the side-effecting function,
generating a new push-based stream having notifications with a value as determined by an accumulator function,
generating a second resulting push-based stream having at least one notification with a respective given value prepended to notifications generated based upon a second provided push-based stream, and
defining notifications which fire back upon themselves using a recurse operator.

19. The tangible machine-readable medium of claim 16, wherein the plurality of operators perform actions comprising:
deferring execution of a function, which returns a notification, until a handler is added to process the returned notification, and
providing a given name to a notification.

20. The tangible machine-readable medium of claim 16, wherein the plurality of operators comprise:
a first operator that generates a fifth resulting push-based stream and caches a last notification of the first resulting push-based stream such that a later-added handler will fire the last notification before firing remaining notifications of the fifth resulting push-based stream;
a second operator that generates a sixth resulting push-based stream that is identical to one of a plurality of provided push-based streams to fire a notification first;
a third operator that generates a notification of a seventh resulting push-based stream by taking a last known notification from each of a plurality of sixth provided push-based streams when one of the plurality of sixth provided push-based streams fires a notification, and invokes a given selector function; and
a fourth operator that generates notifications of an eighth resulting push-based stream by taking a last known notification from each of a plurality of seventh provided push-based streams when a notification fires on any of the plurality of seventh provided streams, invokes a selector function, and fires a result as a notification of the eighth resulting push-based stream.
